(19) United States
(12) Patent Application Publication
(10) Pub. No.: US 2009/0303184 A1
(43) Pub. Date: Dec. 10, 2009

(54) HANDHELD ELECTRONIC PRODUCT AND CONTROL METHOD FOR AUTOMATICALLY SWITCHING AN OPERATING MODE

(75) Inventors: Yi-Wei TAO, Taipei Hsien (TW); Ming-Jen HUANG, Taipei Hsien (TW)

Correspondence Address: LADAS & PARRY, 5670 WILSHIRE BOULEVARD, SUITE 2100, LOS ANGELES, CA, 90036-5679, US

(73) Assignee: WISTRON CORPORATION, Taipei Hsien (TW)

(21) Appl. No.: 12/335,134

(22) Filed: Dec. 15, 2008

(30) Foreign Application Priority Data
Jun. 4, 2008 (TW) 097120722

(51) Int. Cl. G06F 3/033

(52) U.S. Cl. 345/163

(57) ABSTRACT

A handheld electronic product that is capable of automatically switching between operating modes includes a mouse module for outputting a mouse signal when operated on a plane surface, an angle detection module, and a control module. The angle detection module detects changes in angular orientation between the handheld electronic product and a horizontal plane, and outputs a detection signal. The control module switches to a mouse mode upon determining that the angular orientation indicated in the detection signal is a horizontal orientation, and to a non-mouse mode when otherwise. The control module controls output of the mouse signal when in the mouse mode, and disables output of the mouse signal when in the non-mouse mode.

### CROSS-REFERENCE TO RELATED APPLICATION

This application claims priority of Taiwanese Application No. 097120722, filed on Jun. 4, 2008.

### BACKGROUND OF THE INVENTION

1. Field of the Invention

The invention relates to a handheld electronic product and a control method thereof, more particularly to a handheld electronic product and a control method for automatically switching an operating mode.

2. Description of the Related Art

Electronic products that incorporate a remote control function and a mouse function, or a telephone function and a mouse function are available on the market. Smart phones that incorporate a wide variety of functions are also the current trend. However, as to how to switch between different operating modes, aside from using a hardware button for switching, software is also used to provide options indicating different functions on a screen for selection by a user.

Taking an electronic product that incorporates a telephone function and a mouse function as an example, in case there is an incoming call while the user is using the electronic product in a mouse mode, the user must either press a button or select an option on a screen in order to switch to a telephone mode for answering the incoming call. However, the user might press the wrong button because his hands are busy or might take some time before finding the correct option, which is inconvenient to the user.

Taiwanese Invention Application No. 94131702 discloses an automatic switching technique that utilizes an accelerometer to detect changes in external forces applied on an electronic product to switch a power mode. However, this prior art is unable to switch to a corresponding operating mode according to the angular orientation of the electronic product when the latter is in use.

### SUMMARY OF THE INVENTION

Since an electronic product has a particular angular orientation when in use, for example, a mouse is operated for movement on a horizontal plane, or a mobile phone is normally held upright (non-horizontal plane) beside a user's ear during a conversion, information about the angular orientation of the electronic product can be used as a basis for determining whether to automatically switch the operating mode of the electronic product.

Therefore, an object of the present invention is to provide a handheld electronic product and a control method for automatically switching an operating mode according to the angular orientation of the handheld electronic product when in use.

As such, the handheld electronic product capable of automatically switching between operating modes according to this invention includes a control module, a mouse module for outputting a mouse signal when operated on a plane surface, and an angle detection module for detecting changes in angular orientation between the handheld electronic product and a horizontal plane and outputting a detection signal.

The control module switches to a mouse mode upon determining that the angular orientation indicated in the detection signal is a horizontal orientation, and to a non-mouse mode when otherwise. The control module controls output of the mouse signal when in the mouse mode, and disables output of the mouse signal when in the non-mouse mode.

Preferably, the aforesaid handheld electronic product is a computer peripheral device that is adapted for use with a computer. The computer peripheral device outputs a mouse signal in the mouse mode, and a voice signal in the non-mouse mode.

The control method for automatically switching an operating mode of a handheld electronic product according to this invention includes: a) detecting changes in angular orientation between the handheld electronic product and a horizontal plane and outputting a detection signal; and b) switching to a mouse mode upon determining that the angular orientation indicated in the detection signal is a horizontal orientation, and to a non-mouse mode when otherwise. Output of a mouse signal is controlled when in the mouse mode, and output of the mouse signal is disabled when in the non-mouse mode.

In the handheld electronic product and control method for automatically switching an operating mode of the present invention, the switching principle is based on the different angular orientations of the handheld electronic product in the different operating modes. Since the present invention enables automatic switching of the operating mode by detecting changes in the angular orientation between the handheld electronic product and a horizontal plane, the time the user takes to perform manual switching can be reduced, which in effect, makes it more convenient for the user.

### BRIEF DESCRIPTION OF THE DRAWINGS

Other features and advantages of the present invention will become apparent in the following detailed description of the preferred embodiment with reference to the accompanying drawings, of which:

FIG. 1 is a system block diagram to illustrate the preferred embodiment of a handheld electronic product capable of automatically switching between operating modes according to the present invention, which is embodied in a computer peripheral device;

FIG. 2 is a schematic view to illustrate the computer peripheral device when operated on a planar surface as a mouse;

FIG. 3 is a schematic view to illustrate the computer peripheral device when operated as a remote controller;

FIG. 4 is a schematic view to illustrate the computer peripheral device when operated as a network telephone;

FIG. 5 is a schematic view to illustrate another application of the computer peripheral device as a mobile phone;

FIG. 6 is a schematic view to illustrate left and right buttons of the computer peripheral device as corresponding to left and right mouse buttons when used as a mouse, and to off-hook and on-hook buttons when in a talk mode; and

FIG. 7 is a flow chart illustrating consecutive steps of the preferred embodiment of a control method for automatically switching an operating mode of a handheld electronic product according to the invention.

### DETAILED DESCRIPTION OF THE PREFERRED EMBODIMENT

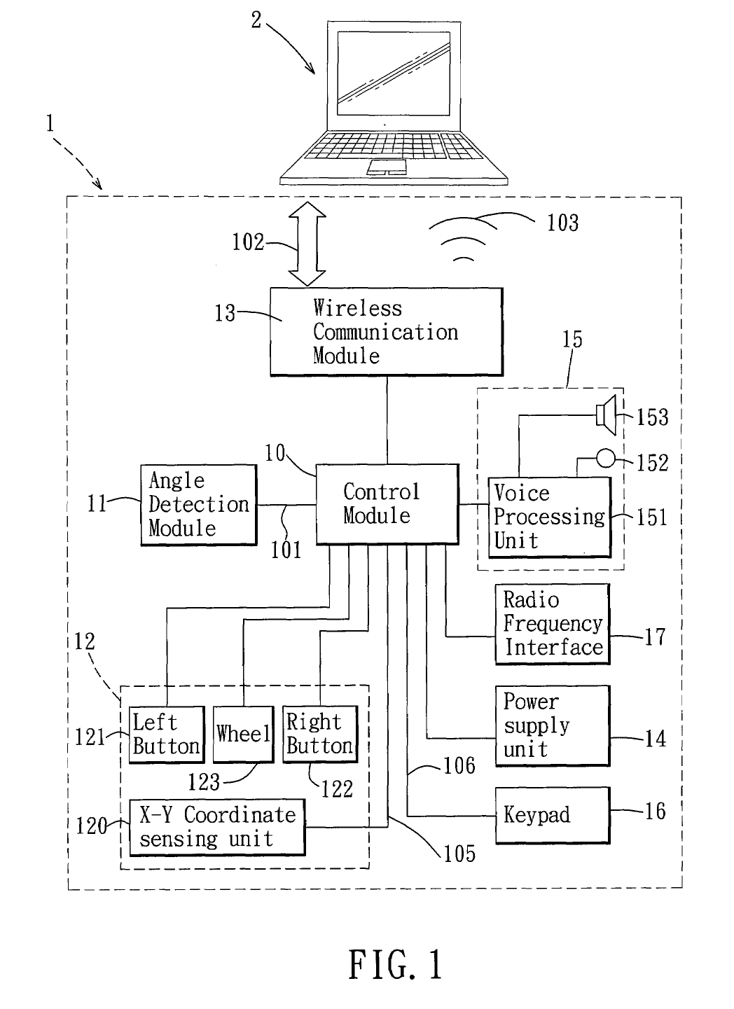

Referring to FIG. 1, the preferred embodiment of a handheld electronic product capable of automatically switching between operating modes according to the present invention is a computer peripheral device 1 that is adapted for use with a computer 2. The computer peripheral device 1 includes a control module 10, an angle detection module 11, a mouse module 12, a wireless transmission module 13, a power supply module 14, a talk module 15, and a keypad 16.

In this embodiment, the wireless transmission module 13 can be a Bluetooth interface that serves as a wireless signal transmission communication interface with the computer 2. It is to be noted that other wired transmission interfaces/wireless transmission interfaces can also be employed, a detailed description of which will be dispensed with herein for the sake of brevity.

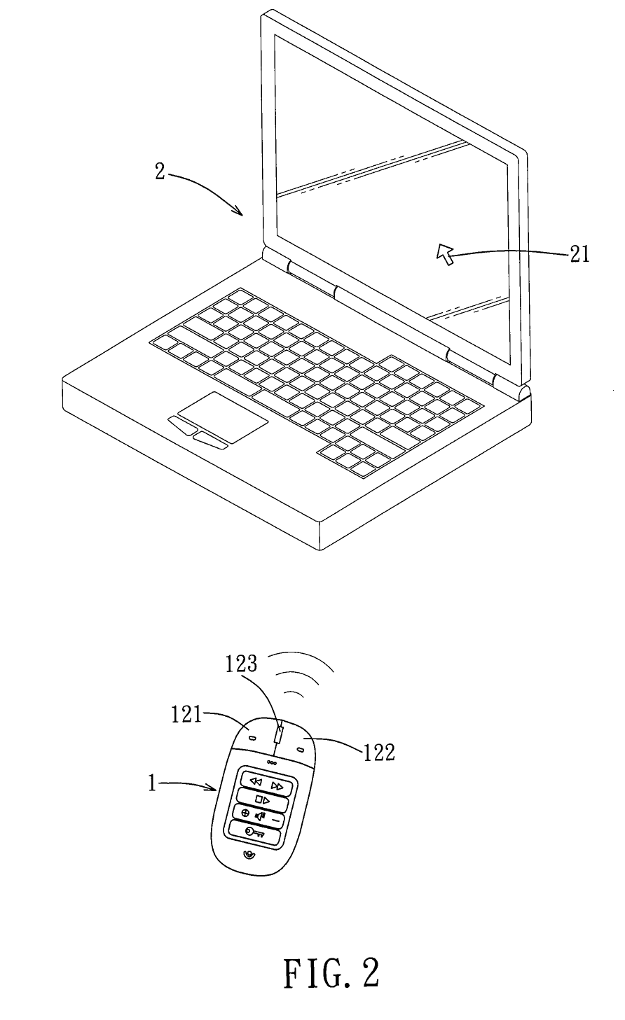

Reference is now made to FIGS. 1 and 2. The mouse module 12 is an optical mouse component that operates on a horizontal plane surface and has a X-Y coordinate sensing unit 120, a left button 121, a right button 122, and a mouse wheel 123.

With respect to the mouse function, the X-Y coordinate sensing unit 120 is an optical coordinate sensing unit that generates light to be reflected by the horizontal plane surface and that detects the reflected light to obtain a mouse signal 105 containing X-Y coordinates. The control module 10 controls the wireless transmission module 13 for converting the mouse signal 105 into a wireless transmission signal 103 that is outputted to the computer 2, thereby resulting in a mouse cursor 21 on a screen of the computer 2.

When the mouse module 12 departs from the horizontal plane surface, since it is not able to receive the reflected light, output of the mouse signal 105 by the X-Y coordinate sensing unit 120 is disabled. Since the mouse signal 105 is disabled when the mouse module 12 is not operated on the horizontal plane surface, the control module 10 can also utilize the mouse signal 105 for determining whether to enter the mouse mode.

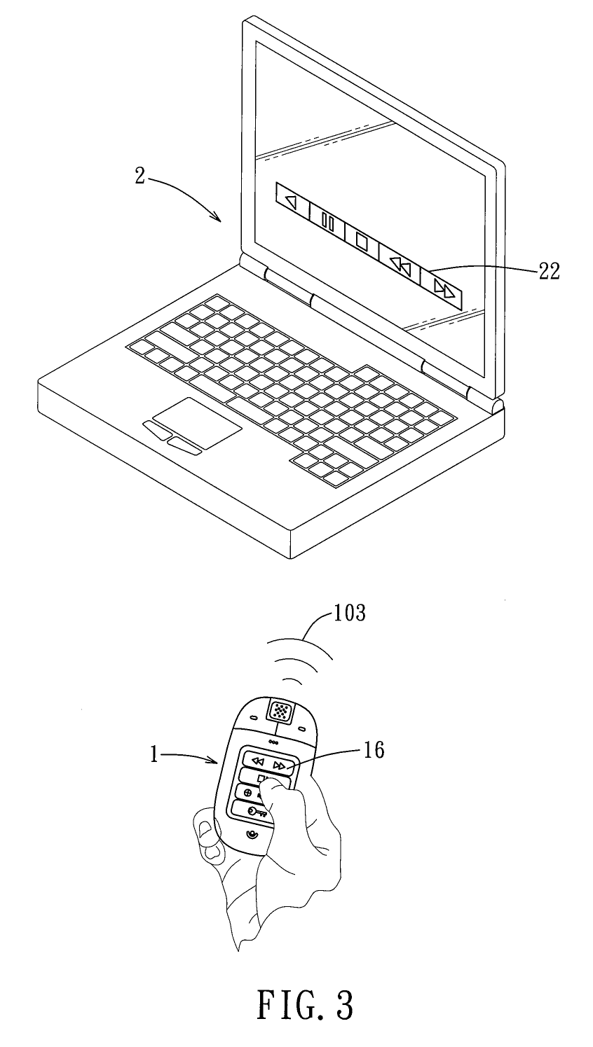

As shown in FIGS. 1 and 3, when the computer peripheral device 1 is used as a remote controller, the keypad 16 can be actuated by the user to generate an actuating signal 106 for the control module 10. When the control module 10 is in a remote control mode, a control command corresponding to the actuating signal 106 is encoded into a wireless transmission signal 103 through the wireless transmission module 13 for output to the computer 2 having a Bluetooth transmission function.

Once the computer 2 receives the wireless transmission signal 103 and decodes the control command, playback, pause or fast forward functions of an audio/video playback interface 22 installed in the computer 2 can be controlled according to the control command.

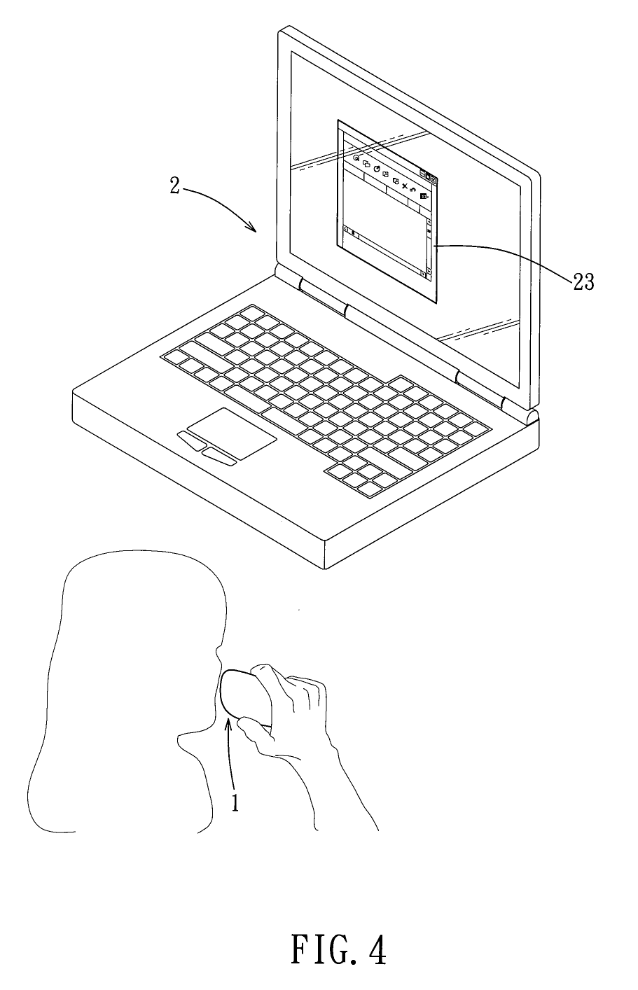

Referring to FIGS. 1 and 4, the talk module 15 has a voice processing unit 151, a microphone 152, and a speaker 153. When the computer peripheral device 1 is used as a network telephone, the control module 10 is operated in a talk mode so that the microphone 152 and the speaker 153 can respectively pick up and reproduce sound. The voice processing unit 151 is responsible for processing a voice signal, which is provided to the wireless transmission module 13 for conversion into a wireless transmission signal 103 carrying voice data for output to the computer 2.

After the computer 2 receives the wireless transmission signal 103 and decodes the voice data, the voice data is provided to a network telephone interface 23, such as Skype, installed in the computer 2 so that the user can use the computer peripheral device 1 and the network telephone interface 23 to converse with another party.

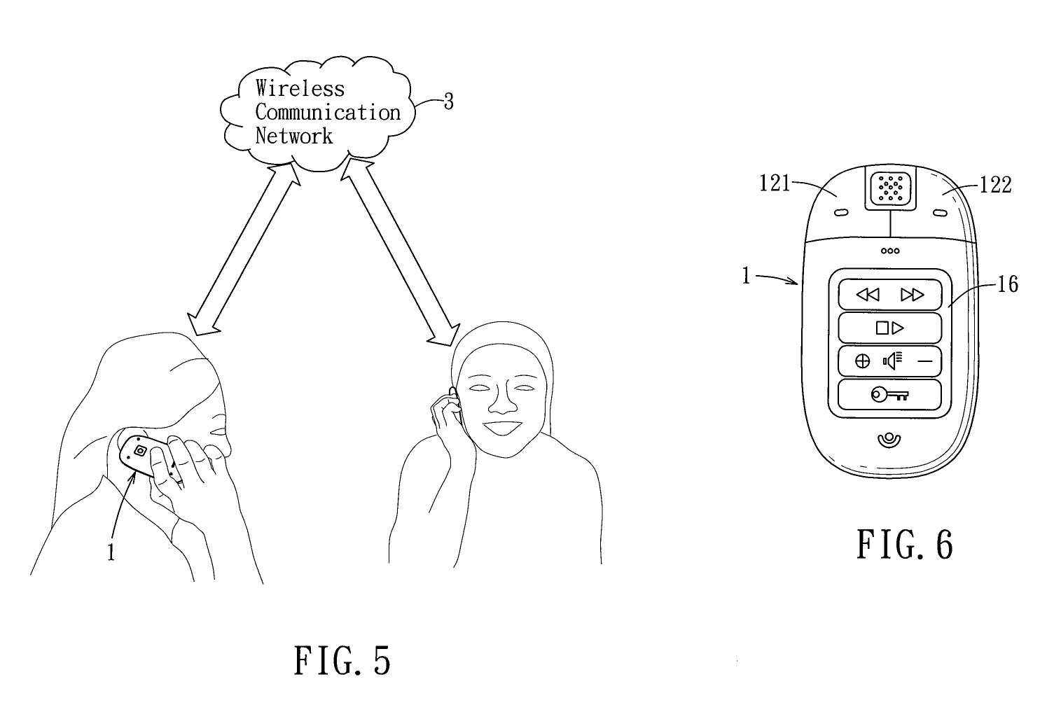

With reference to FIGS. 1 and 5, the computer peripheral device 1 can have another application as a mobile phone. This can be achieved by changing the wireless transmission module 13 with a radio frequency interface 17 found in mobile phones. When the control module 10 is operated in a talk mode of the mobile phone, a radio frequency signal carrying voice data can be provided to a wireless communication network 3, i.e., the communication network of the mobile phone, through the radio frequency interface 17, for conversing with another party.

Referring to FIG. 6, the computer peripheral device 1 is equipped with left and right buttons 121, 122. When operating in the mouse mode, each of the buttons 121, 122 corresponds to a respective one of left and right mouse buttons. When operating in the talk mode (e.g., network telephone), each of the buttons 121, 122 corresponds to a respective one of off-hook and on-hook buttons. In the talk mode, the keypad 16 can cooperate with a phone book of the network telephone interface 23 such that the user is able to select a contact in the phone book through the keypad 16.

Referring back to FIG. 1, the angle detection module 11 is one of a magnetic sensor and a gyroscope. The angle detection module 11 detects changes in angular orientation between the computer peripheral device 1 and a horizontal plane, and outputs a detection signal 101 to the control module 10. Thereafter, the control module 10 determines an appropriate operating mode to enter depending on the angular orientation indicated in the detection signal 101.

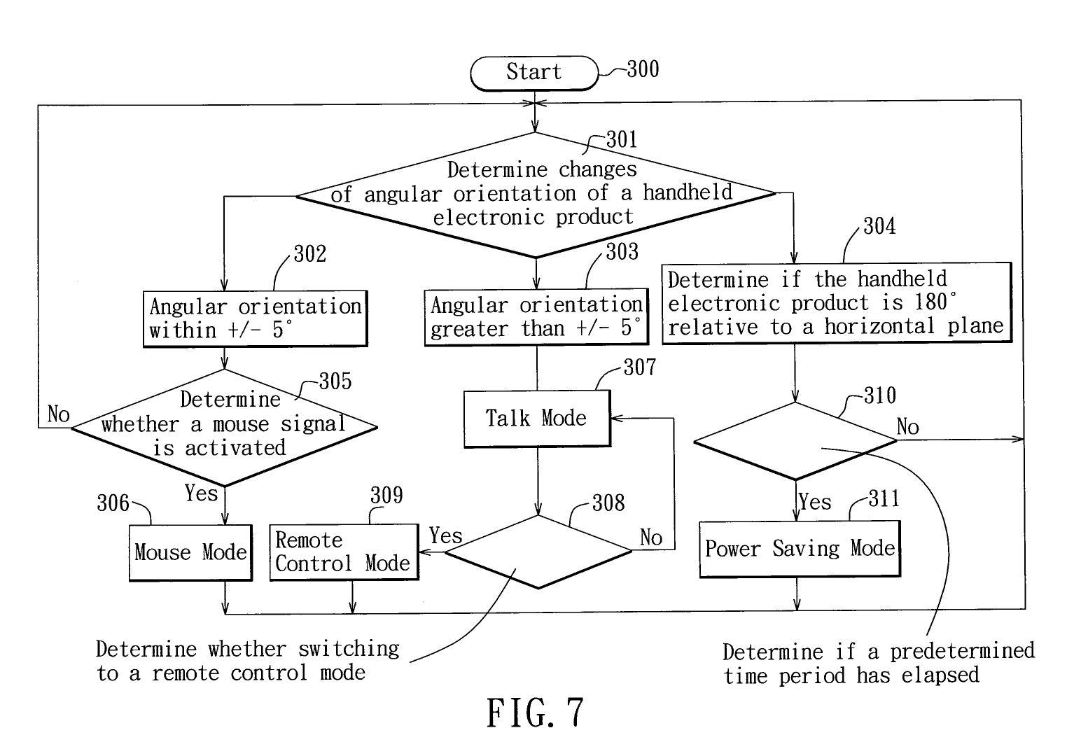

Referring to FIG. 7, there is shown a flow chart of a control method for automatically switching the operating mode of the handheld electronic product.

After the computer peripheral device 1 is turned on (step 301), the control module 10 determines the current angular orientation of the computer peripheral device 1 based on the detection signal 101 (step 301). There are three categories of possible angular orientations in this embodiment: (step 302) the angle is within +/−5 degrees relative to a horizontal plane, (step 303) the angle is beyond the range of +/−5 degrees relative to a horizontal plane, and (step 304) the angle is 180 degrees relative to the horizontal plane.

In a first scenario, when the control module 10 determines the angle to be within +/−5 degrees relative to the horizontal plane (step 302), the control module 10 determines whether a signal generated by the mouse module 12 is valid (step 305). If valid, the control module 10 enters the mouse mode.

In a second scenario, when the control module 10 determines the angle to be beyond the range of +/−5 degrees relative to the horizontal plane (step 303), which indicates a current non-mouse mode, the control module 10 enters a voice communication mode (i.e., talk mode) directly (step 307), and then determines whether to switch to the remote control mode (step 308). The switching act can be conducted through manual actuation of the keypad 16 by the user to operate a preset button or a software option. If switching to the remote control mode is desired, the control module 10 enters the remote control mode (step 309). Otherwise, the control module 10 remains in the voice communication mode (step 307).

In a third scenario, when the control module 10 determines the angle to be 180 degrees relative to the horizontal plane (step 304), the control module 10 further determines if a predetermined time period has elapsed (step 310). If the predetermined time period has elapsed, the control module 10 enters a power saving mode directly (step 311). If the predetermined time period has not elapsed, the flow goes back to step 301.

It should be noted herein that the present invention is not limited to the aforementioned angular settings used in the preferred embodiment, which may be adjusted depending on actual requirement. In other embodiments, the angular settings may be modified by the user through a hardware or software design.

In view of the above, in the handheld electronic product and control method for automatically switching an operating mode of the present invention, the switching principle is based on the different angular orientations of the handheld electronic product in the different operating modes. Since the present invention enables automatic switching of the operating mode by detecting the changes in the angular orientation between the handheld electronic product and a horizontal plane, the time the user takes to perform manual switching can be reduced, which in effect, makes it more convenient for the user.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A handheld electronic product capable of automatically switching between operating modes, comprising:
a mouse module for outputting a mouse signal when operated on a plane surface;
an angle detection module for detecting changes in angular orientation between the handheld electronic product and a horizontal plane and outputting a detection signal; and
a control module for switching to a mouse mode upon determining that the angular orientation indicated in the detection signal is a horizontal orientation, and to a non-mouse mode when otherwise, said control module controlling output of the mouse signal when in the mouse mode, and disabling output of the mouse signal when in the non-mouse mode.

2. The handheld electronic product as claimed in claim 1, further comprising a talk module for generating a voice signal, said control module switching to a talk mode upon determining the non-mouse mode, and controlling output of the voice signal when in the talk mode.

3. The handheld electronic product as claimed in claim 2, wherein said control module enters the talk mode upon determining that the detection signal is one associated with an angle larger than a predetermined angle of the horizontal plane.

4. The handheld electronic product as claimed in claim 2, further comprising two buttons, each of which corresponds to a respective one of left and right mouse buttons when in the mouse mode, and to a respective one of off-hook and on-hook buttons when in the talk mode.

5. The handheld electronic product as claimed in claim 1, further comprising a keypad for generating a control command when actuated, said control module being capable of switching to a remote control mode for outputting the control command to a computer.

6. The handheld electronic product as claimed in claim 1, wherein said angle detection module is one of a magnetic sensor and a gyroscope.

7. The handheld electronic product as claimed in claim 1, wherein said control module controls the handheld electronic product to enter a power saving mode upon determining that the handheld electronic product is rotated 180 degrees relative to the horizontal plane and a predetermined time period has elapsed.

8. The handheld electronic product as claimed in claim 2, wherein said handheld electronic product is a computer peripheral device that is adapted for use with a computer;
said computer peripheral device further comprising a wireless transmission module for transmitting one of said voice signal and said mouse signal to the computer.

9. The handheld electronic product as claimed in claim 2, wherein said handheld electronic product is a mobile phone and further comprises a radio frequency interface for transmitting said voice signal to a wireless communication network of said mobile phone.

10. A control method for automatically switching an operating mode of a handheld electronic product, comprising:
a) detecting changes in angular orientation between the handheld electronic product and a horizontal plane, and outputting a detection signal; and
b) switching to a mouse mode upon determining that the angular orientation indicated in the detection signal is a horizontal orientation, and to a non-mouse mode when otherwise, output of a mouse signal being controlled when in the mouse mode, output of the mouse signal being disabled when in the non-mouse mode.

11. The control method for automatically switching an operating mode of a handheld electronic product as claimed in claim 10, wherein step b) includes:
switching to a talk mode upon determining that the angular orientation indicated in the detection signal is a non-horizontal angular orientation, and controlling output of a voice signal when in the talk mode.

12. The control method for automatically switching an operating mode of a handheld electronic product as claimed in claim 10, wherein the handheld electronic product is further capable of being actuated to switch to a remote control mode.

13. The control method for automatically switching an operating mode of a handheld electronic product as claimed in claim 10, further comprising:
c) causing the handheld electronic product to enter a power saving mode upon determining that the handheld electronic product is rotated 180 degrees relative to the horizontal plane and a predetermined time period has elapsed.
